(19) United States
(12) Patent Application Publication
(10) Pub. No.: US 2024/0428147 A1
(43) Pub. Date: Dec. 26, 2024

(54) CUSTOMIZING BATTERY CONFIGURATIONS FOR ELECTRIC PARCEL DELIVERY VEHICLES

(71) Applicant: INTERNATIONAL BUSINESS MACHINES CORPORATION, ARMONK, NY (US)

(72) Inventors: Sarbajit K. Rakshit, Kolkata (IN); Jagabondhu Hazra, Bangalore (IN); Manikandan Padmanaban, Chennai (IN)

(21) Appl. No.: 18/212,819

(22) Filed: Jun. 22, 2023

(51) Int. Cl. G06Q 10/047; B60L 58/13; G06Q 10/083

(52) U.S. Cl. CPC G06Q 10/047; B60L 58/13; G06Q 10/083; B60L 2240/26; B60L 2240/64; B60L 2250/16; B60L 2260/54; B60L 2270/10

(57) ABSTRACT

A method, computer program product, and computer system for configuring a battery pack. Parcel delivery instructions including parcel level information, at least one electric vehicle property, and a first location and one or more destinations are received. A trained artificial intelligence model is used to extract an expected battery consumption of the electric vehicle for each of the plurality of potential routes, and to identify a delivery route that has a lowest expected battery consumption. Battery service options are mapped along the delivery route. Simulations of the electric vehicle completing the delivery are performed. A size of a battery pack to be used with the electric vehicle at a start of the delivery route at the first location is configured, and a battery pack service schedule for servicing the battery pack between the first location and the one or more destinations is configured, as a function of the multiple simulations.

### BACKGROUND

The present invention relates to customizing battery pack configurations for an electric vehicle (EV), and more specifically, to improving parcel level emission by dynamically selecting a battery configuration for the parcel delivery EV based on parcel load and contextual conditions.

### SUMMARY

Embodiments of the present invention provide a method, a computer program product, and a computer system, for configuring battery packs that minimize a carbon footprint of a parcel.

One or more processors of a computer system receive parcel delivery instructions including parcel level information, at least one electric vehicle property, and a first location and one or more destinations are received. A trained artificial intelligence model is used to extract, from a plurality of potential routes connecting the first location to the one or more destinations, an expected battery consumption of the electric vehicle for each of the plurality of potential routes, and to identify, based on the expected battery consumption, a delivery route to be used by the electric vehicle that has a lowest expected battery consumption. Battery service options are mapped along the delivery route. Simulations of the electric vehicle completing the parcel delivery instructions along the delivery route are performed. A size of a battery pack to be used with the electric vehicle at a start of the delivery route at the first location is configured, and a battery pack service schedule for servicing the battery pack between the first location and the one or more destinations is configured, as a function of the multiple simulations.

### BRIEF DESCRIPTION OF THE DRAWINGS

FIG. 1 depicts a computing environment which contains an example of an environment for the execution of at least some of the computer code involved in performing the inventive methods, in accordance with embodiments of the present invention.

FIG. 2 is a block diagram of modules included in code included in the system of FIG. 1, in accordance with embodiments of the present invention.

FIG. 3 is a flow chart of an embodiment of a method for configuring battery packs that minimize a carbon footprint of a parcel, in accordance with embodiments of the present invention.

FIG. 4A depicts a plurality of potential routes to complete a delivery operation, in accordance with embodiments of the present invention.

FIG. 4B depicts exemplary road profile data used as inputs for a trained artificial intelligence model, in accordance with embodiments of the present invention.

FIG. 5 depicts the map of FIG. 4A with battery service locations displayed along with the potential routes, in accordance with embodiments of the present invention.

FIG. 6 depicts relationships between a first AI model and a second AI model, in accordance with embodiments of the present invention.

### DETAILED DESCRIPTION

### Overview

Currently, emissions associated with transportation contributes a significant percentage of total emission. To reduce emission, transportation and distribution companies are moving towards electric transportation using EV delivery and transportation trucks. A weight of the battery pack in EVs can be around 25% of the EV's weight. An average load for a transportation vehicle uses only approximately half of the full capacity of the battery banks. Embodiments of the present invention propose dynamically configuring a battery pack (e.g. size of the battery) based on parcel load (e.g. weight of parcels on truck) and contextual conditions (e.g. distance, road type, road profile, weather condition, traffic conditions, and battery service options for recharging/replacing battery pack). Configuring the battery pack and a service plan for recharging/replacing the battery pack minimizes package-level emission.

Based on capabilities of the road (e.g. wireless recharge while the EV is travelling, wired recharge when the EV is stopped, and recharge time, on road battery replacement service to the EV, etc.), embodiments of the present invention simulates the journey of the EV along a delivery route to identify how much weight of battery pack is to be loaded on the EV so that, per unit weight of a parcel load, the carbon footprint consumption is optimized/reduced. The battery pack of the EV (e.g. size and/or weight) will thus be customized for a specific delivery/transportation operation. Based on a need of minimizing carbon footprint per unit weight of parcel load, a required number of batteries module can be removed, replaced, or added to configure the battery pack.

A road surface profile (e.g. elevation changes requiring the EV to climb up or down) is used as a contextual condition to configure the battery pack and battery service plan for the specific delivery/transport operation. Weather parameters (e.g. wind flow direction and speed with respect to vehicle movement direction and speed) and traffic conditions may also be used as a contextual condition to configure the battery pack and battery service plan for the specific delivery/transport operation. For instance, embodiments of the present invention identifies when the battery weight is to be reduced (e.g. EV needs to climb up a hill) and when to attach the battery with the vehicle, so that a carbon footprint consumption is optimum per unit of parcel load.

Based on the simulated result(s) for optimum carbon footprint consumption per unit weight of package, parcel transportation and delivery service providers can proactively arrange the services to the EV transportation truck, for example, making sure a battery is available which is to be replaced to the vehicle, or a charging station can accommodate the need to recharge in a timely manner, so that transportation time remains efficient.

In an embodiment, a trained artificial intelligence (AI) model extracts properties of potential routes where the EV will be travelling to determine an expected battery consumption for each potential route. The trained AI model outputs a delivery route from the potential routes based on which route has a lowest expected battery consumption, even if the route potentially is a slower route. The inputs to the trained AI model include map data, distance between start and end points, parcel information, a road surface profile, traffic conditions, weather conditions, and a presence of battery service options such as on road wireless charging of the vehicles, recharging stations, and battery service technicians. A total number of packages, volume of the packages, and associated weights being transported are identified, as well as if any on road delivery is also planned. On road recharging of vehicle batteries, recharging time of the vehicle, and whether on road battery delivery is possible will be considered. The self-weight of the vehicle and the self-weight of the battery, and how much power will be consumed per unit weight of the parcel load is also considered.

Based on a simulated result(s), a battery pack, which results in an optimum carbon footprint consumption per unit of parcel load, is configured. Further, a travel plan for the EV may also be configured, which includes when to wireless recharge the EV, when the battery pack or replacement thereof is to be supplied to the EV and discharged battery is to be removed from the EV, when and for how long the EV needs to be recharged, and appropriate combinations of recharging the battery with wireless and with wire power transmission. Based on the identified plan, parcel transportation and delivery service providers can proactively arrange the mode of transmission of power to the EV so that an optimum level of carbon footprint can be ensured for unit weight of parcel load.

### Computing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

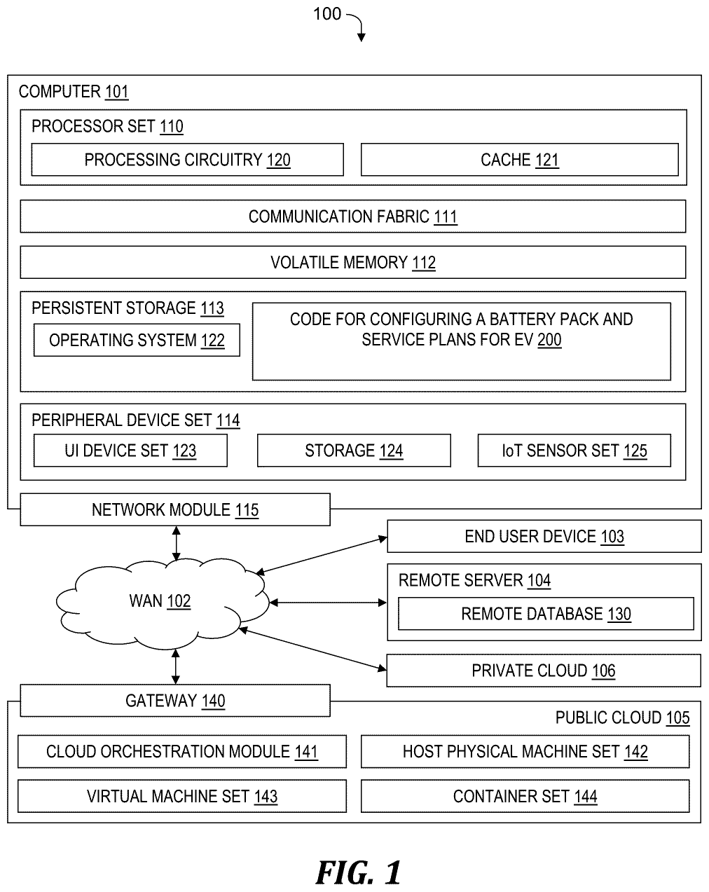

FIG. 1 depicts a computing environment which contains an example of an environment for the execution of at least some of the computer code involved in performing the inventive methods, in accordance with embodiments of the present invention. Computing environment 100 contains an example of an environment for the execution of at least some of the computer code involved in performing the inventive methods, such as code 200 for configuring a battery pack and battery service plans for an EV. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

### System and Process for Battery Pack Configuration

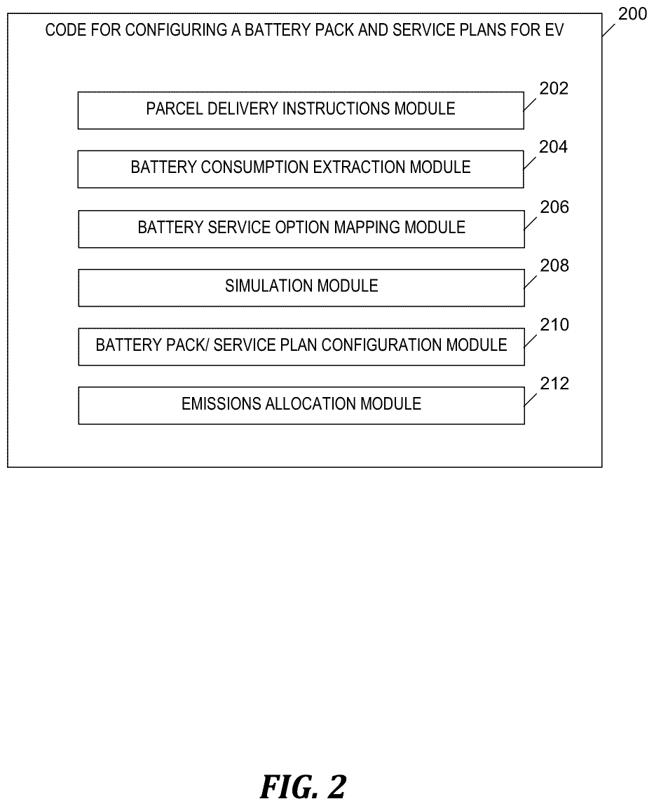

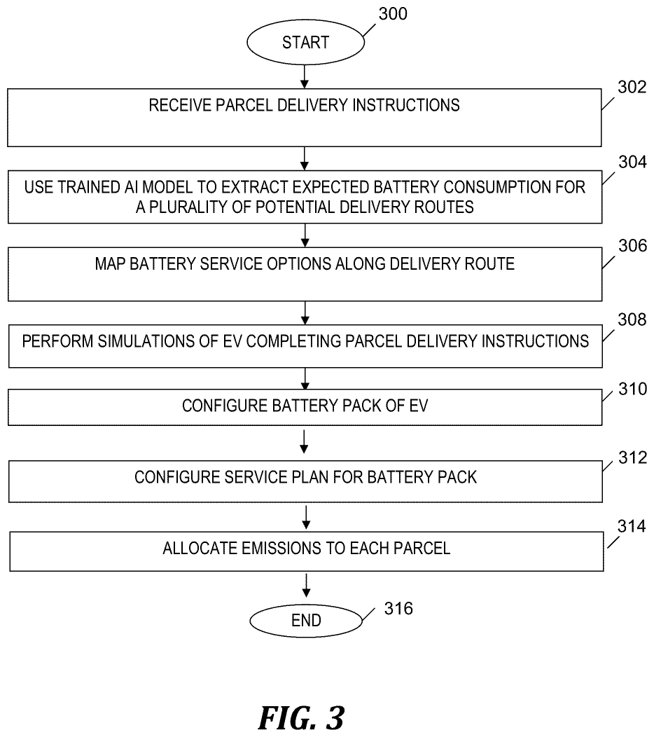

FIG. 2 is a block diagram of modules included in code included in the system of FIG. 1, in accordance with embodiments of the present invention. Code 200 includes a parcel delivery instructions module 202, a battery consumption extraction module 204, a battery service option mapping module 206, a simulation module 208, a battery pack/service plan configuration module 210, and an emissions allocation module 212. The number of modules can vary and some modules may be combined with other modules or separated into two or more modules. The functionality of the modules included in code 200 is discussed in detail in the discussion of FIG. 3, which is presented below.

FIG. 3 is a flowchart of a process of configuring a battery pack for an EV, where the operations of the flowchart are performed by the modules in FIG. 2, in accordance with embodiments of the present invention. The process of FIG. 3 begins at a start node 300.

In step 302, parcel delivery instructions module 202 (see FIG. 2) receives parcel delivery instructions including parcel level information, at least one electric vehicle property, and a first location and one or more destinations.

The parcel level information includes a total number of parcels being transported by the electric vehicle and a weight of each parcel. The total number of parcels being transported by the electric vehicle can be retrieved from one or more databases or servers storing parcel information, which is populated and potentially maintained by a shipping and receiving company or supply chain management company. For example, a company responsible for receiving, loading, and delivering parcels to destinations inputs the total number of parcels to be loaded onto the electric vehicle into one or more computers, which can be retrieved by the parcel delivery instructions module 202. The total number of parcels to be loaded onto the electric vehicle may be determined in a scheduling or load operations phase using various logistics software or may be determined at a time of loading the electric vehicle whereby a bar code or similar computer readable label affixed to each parcel is individually scanned by an operator and the scanned data is transmitted to one or more databases or servers storing parcel information. Both the load operations/scheduling phase and on-site data collection on the total number of parcels to be loaded on the electric vehicle may be used. For example, a load operations operator or software programmed to determine the total number of packages to be loaded on the electric vehicle may be used, and an on-site scanning protocol may serve to confirm an actual total number of parcels loaded on the electric vehicles. Other methods of determining the total number of parcels to be loaded on the electric vehicle for completion of a delivery operation may be used.

The weight of each parcel being transported by the electric vehicle can be retrieved from one or more databases or servers storing parcel information, which is populated and potentially maintained by the same shipping and receiving company or supply chain management company determining the total number of parcels to be loaded on the electric delivery vehicle, and potentially determines the weight of parcel in same operation as determining the total number of parcels. For example, a company responsible for receiving, loading, and delivering parcels to destinations inputs the weight of each parcel into one or more computers, which can be retrieved by the parcel delivery instructions module 202. The weight of the parcels may be determined at the time of packaging using one or more weight sensors at the packing facility/warehouse, whereby the data corresponding to the weight is transmitted to one or more databases or servers storing parcel information. As the parcels are loaded onto the electric vehicle, an operator may scan a barcode or similar computer-readable label affixed to each parcel, which provides the exact weight of the parcel loaded onto the electric vehicle; the scanned weight data is transmitted to one or more databases or servers storing parcel information. Other methods of determining the weight of each parcel to be loaded on the electric vehicle for completion of a delivery operation may be used.

The at least one electric vehicle property includes a total weight (kg) of the electric vehicle, an initial weight (kg) of a battery pack, and an initial capacity (kWh) of the battery pack. The total weight of the electric vehicle can be retrieved from one or more databases or servers storing electric vehicle information, which is populated and potentially maintained by a shipping and receiving company, electric vehicle manufacturer(s), or government database containing electric vehicle specifications. Similarly, the total weight of the battery pack can be retrieved from one or more databases or servers storing electric vehicle information, which is populated and potentially maintained by a shipping and receiving company, electric vehicle manufacturer(s), or government database containing electric vehicle specifications. The total weight of the battery pack may be broken down into a weight of the battery pack without cells, a weight of the battery pack with a full capacity of cells, and a weight of the battery pack with “x” number of cells. The weight of each cell is also known and can retrieved to calculate a total weight of the battery pack with “x” amount of cells. Still further, the parcel delivery instructions module 202 can retrieve a battery capacity of the battery pack of the electric vehicle to be used for a delivery operation, for example, by accessing one or more databases or servers storing electric vehicle information, which is populated and potentially maintained by a shipping and receiving company, electric vehicle manufacturer(s), or government database containing electric vehicle specifications. The battery capacity refers to an amount of energy contained in the battery pack, expressed as kilowatt-hours which is a power output of the battery pack over a period of time.

Further, at least one property of the electric vehicle is a mode or type of electric vehicle. The various types of electric vehicles include an electric car, electric truck, electric heavy-duty truck, electric scooter, electric motorbike, golf cart, electric mail delivery truck, electric semi-trailer truck, or any battery powered vehicles having at least one wheel. Another type of electric vehicle can include aerial vehicles capable of transporting a parcel through the air and effecting delivery of the parcel at a targeted location. The type of electric vehicle affects the weight, parcel load capacity, and also affects a manner in which the battery cells are repaired, replaced, services, removed, etc., a manner in which the electric vehicle's battery can be recharged, and locations that can accommodate the electric vehicle during charging.

The parcel level information received by the parcel delivery instructions module 202 further includes a first location and one or more destinations. The first location is a starting point of the electric vehicle completing a delivery operation of one or more parcels. In an embodiment, the first location is a warehouse or other vehicle loading facility where parcels are loaded onto the electric delivery vehicle for delivery. In another embodiment, the starting point could be any geographical location. The one or more destinations are delivery locations, such as an address, a PO box, a business, a residence, etc., where one or more parcels loaded on the electric vehicle will be delivered. In an embodiment, the one or more destinations are connected to each other and the first location via roads, highways, paths, or any surface that allows for conveyance of an electric vehicle. In alternative embodiments, the one or more destinations are connected to each other and to the first location via various flight paths of electric aerial vehicles capable of transporting a parcel through the air and effecting delivery of the parcel at a targeted location.

In step 304, the battery consumption extraction module 204 uses a first trained AI model to extract, from a plurality of potential routes connecting the first location to the one or more destinations, an expected battery consumption of the electric vehicle for each of the plurality of potential routes, and to identify, based on the expected battery consumption, a delivery route to be used by the electric vehicle that has a lowest expected battery consumption.

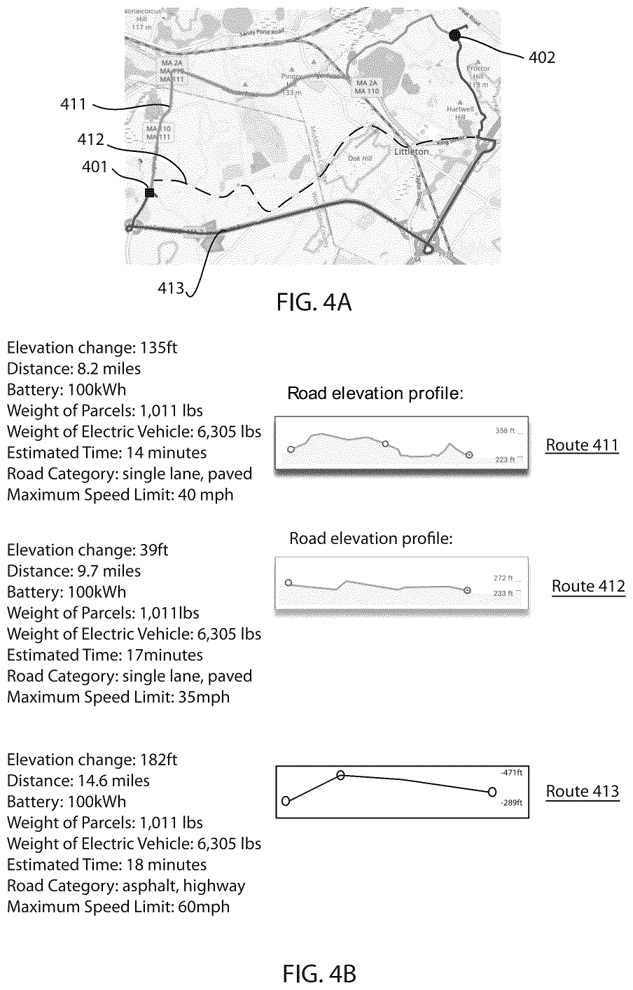

A navigation application is used by the battery consumption extraction module 204 to determine one or more potential routes from the first location to the one or more destination locations. The navigation application calculates an estimated travel time for each of the potential routes. FIG. 4A depicts a plurality of potential routes 411, 412, 413 to complete a delivery operation, in accordance with embodiments of the present invention. The potential routes 411, 412, 413 each connect the first location 401 (e.g. starting location) with a first destination location 402 (e.g. delivery address of residence). In the illustrated embodiment, the route 411 has an estimated travel time of 14 minutes, a total distance of 8.2 miles, comprised mostly of a paved county road that passes through a hilly region of the city, with a maximum speed limit of 40 miles per hour (mph), and only one stop sign. The route 412 has an estimated travel time of 17 minutes, a total distance of 9.7 miles, comprised mostly of a paved single lane roads that, with a maximum speed limit of 35 miles per hour (mph), and four stoplight intersections. The route 413 has an estimated travel time of 18 minutes, a total distance of 14.6 miles, comprised mostly of a paved highway road with a maximum speed limit of 60 miles per hour (mph), and no stop signs. Each route 411, 412, 413 has characteristics that are used to build a road profile of the route.

The road profile of the routes 411, 412, 413 includes a plurality of characteristics of the road(s) connecting the first location 401 to the first destination location 402 via routes 411, 412, 413. The road profile considers road conditions, estimated travel time to destination, elevation changes, number of elevation increases greater than “y” feet over “z” mile(s), grade, pavement type, a path of the road (e.g. curvy or straight), and the like, which can impact an energy output of the battery pack of the electric vehicle. For example, the road(s) needed to travel along routes 411, 412, or 413 might have a large elevation change, which requires more work from the vehicle battery. Paved road(s) are more efficient for travel than non-paved roads, and travelling down straight roads consumes less energy than travelling down curved roads. Road conditions, elevation changes, and road designs can be retrieved from databases such as a geographic information system (GIS) database.

In addition to the road profile, the battery consumption extraction module 204 inputs the total weight of the parcels, an estimated vehicle speed, weather conditions, and traffic conditions into the first trained AI model to output the expected battery consumption.

The total weight of the parcels is calculated using the known weight of each parcel and the total number of parcels loaded on the electric vehicle.

The estimated vehicle speed is calculated using known speed limits, average speed of vehicles along a given route, and one or more safety factors to estimate an average speed the electric vehicle will be traveling along a given route.

Weather conditions impact battery usage if the road surface is wet, slippery, snow-covered, and the like, and can impact battery output and/or charging rate if the temperature is very hot or very cold. Weather conditions include temperature, wind speed, wind direction, humidity, dew point, precipitation, forecasts, radar data, and the like. Weather conditions can be retrieved from weather models and weather forecast models.

Traffic conditions refer to road congestion, likelihood of traffic jams at a given point in time, road construction, and the like. Traffic conditions impact battery usage, for example, if the journey takes longer and the electric vehicle is idling for longer in traffic. Traffic conditions can be retrieved from traffic reports, software applications that provide updates on traffic, traffic prediction models, live camera feeds, and the like.

The inputs for the first trained AI model include structured and unstructured data, and may be obtained from one or more data sources internal to an organization or one or more data sources external to the organization. Dataset(s) are fed into the first AI model to output: 1) an expected battery consumption for each potential route, and 2) the best route of the potential routes for minimizing carbon footprint per unit weight of parcel load, which is a lowest expected battery consumption. The battery consumption is converted into carbon emission to allocate carbon emission to parcel per weight, as described in greater detail infra.

A first output of the first trained AI model is an expected battery consumption for each potential route. For example, the first trained AI model outputs an energy (e.g. in kWh) required for the electric vehicle to travel from the first destination to the first destination and deliver a parcel. FIG. 4B depicts exemplary datasets used as inputs for the first trained AI model, in accordance with embodiments of the present invention. The total weight of the parcels, the weight of the electric vehicle, and the battery of the electric vehicle is the same for all routes because, in this embodiment, the first AI model is outputting an expected battery consumption for the same electric vehicle carrying the same load of parcels across three different routes.

The dataset for route 411, the dataset for route 412, and the dataset for route 413 is input into the first AI model including: 1) elevation change (e.g. ft), 2) distance traveled e.g. (miles), 3) size of battery (e.g. kWh, which can also be expressed as range in miles for electric vehicles), 4) total weight of parcels loaded or planned to be loaded on the electric vehicle (e.g. lbs.), 5) total weight of the electric vehicle (e.g. lbs.), 6) estimated travel time (e.g. minutes), 7) road category (e.g. paved highway), 8) maximum speed (e.g. mph), and 9) road elevation profile, which provides number of elevation changes above a threshold elevation change (e.g. 4 changes in elevation over 40 ft across 1 mile). Although not shown in FIG. 4B, the dataset fed into the first AI model may include weather conditions, traffic conditions, electric vehicle specifications, road curvature, number of turns, number of expected stops, number of stoplights, and delivery time constraints. Based on these inputs, the first trained AI model outputs the expected battery consumption (e.g. in kWh/mile) of the battery pack of the electric vehicle to travel along routes 411, 412, 413 to complete delivery of the parcel.

For route 411, the first trained AI model is provided: 1) an elevation change of 135 ft, 2) a route distance of 8.2 miles, 3) battery size of 100 kWh having a range of 114 miles, 4) weight of parcels of 1,011 lbs., 5) a weight of the electric vehicle 6,305 lbs., 6) estimated time to destination of 14 minutes, 7) road category of single lane, paved, 8) a maximum speed limit of 40 mph, and 9) road elevation profile showing the various elevation changes along the route. The first trained AI model determines that, given all of the conditions and factors, the battery consumption rate is 1.8 kWh, and so the expected energy consumption along route 411 is 14.76 kWh (1.8 kWh*8.2 miles).

For route 412, the first trained AI model is provided: 1) an elevation change of 39 ft, 2) a route distance of 9.7 miles, 3) battery size of 100 kWh having a range of 114 miles, 4) weight of parcels of 1,011 lbs., 5) a weight of the electric vehicle 6,305 lbs., 6) estimated time to destination of 17 minutes, 7) road category of single lane, paved, 8) a maximum speed limit of 35 mph, and 9) road elevation profile showing the various elevation changes along the route. The first trained AI model determines that, given all of the conditions and factors, the battery consumption rate is 1.3 kWh, and so the expected energy consumption along route 412 is 12.61 kWh (1.3 kWh*9.2 miles).

For route 413, the first trained AI model is provided: 1) an elevation change of 182 ft, 2) a route distance of 14.6 miles, 3) battery size of 100 kWh having a range of 114 miles, 4) weight of parcels of 1,011 lbs., 5) a weight of the electric vehicle 6,305 lbs., 6) estimated time to destination of 18 minutes, 7) road category of asphalt, highway, 8) a maximum speed limit of 60 mph, and 9) road elevation profile showing the various elevation changes along the route. The first trained AI model determines that, given the all of the conditions and factors, the battery consumption rate is 1.6 kWh, and so the expected energy consumption along route 413 is 23.16 kWh (1.6 kWh*14.6 miles).

A second output of the first trained AI model is the best route of the potential routes for minimizing carbon footprint per unit weight of parcel load, which is a lowest expected battery consumption. With respect to routes 411, 412, and route 412 has the lowest expected battery consumption, of 12.61 kWh. Thus, the second output of the first trained AI model is route 412, even though it is not the fastest route. While in some embodiments, the process could end here and route 412 would be selected and transferred to a navigational software system of the electric vehicle for delivery. However, embodiments of the present invention provide additional layers of AI modelling and deep learning to improve battery pack configurations of electric vehicles.

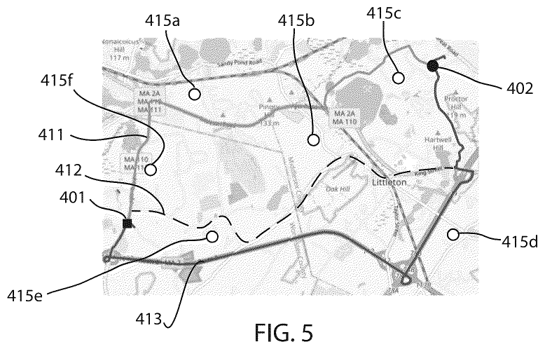

In step 306, battery service option mapping module 206 maps battery service options along the delivery route. Battery service options include charging stations (wired), battery service technicians, wireless charging locations, or any location that can charge a battery pack, swap, remove, repair, or add battery cells of the battery pack. FIG. 5 depicts the map of FIG. 4A with battery service locations 415a-f displayed along with the potential routes 411, 412, 413, in accordance with embodiments of the present invention. Each battery service option 415a-f is capable of modifying the battery pack of the electric vehicle, either by charging the battery pack and physically modifying the battery cells of the battery pack, which impacts the energy capacity of the electric vehicle, and adds time to the delivery.

In step 308, the simulation module 208 performs one or multiple simulations of the electric vehicle completing the parcel delivery instructions along the delivery route by inputting outputs of the first trained AI model into a second trained AI model. The inputs for the second trained AI model output by the first AI model include: 1) route with lowest expected battery consumption and 2) the expected battery consumption for each potential route. Additional inputs for the second AI model include: 1) battery service options 415a-f mapped in proximity to the potential delivery routes, 2) elevation change (e.g. ft), 3) distance traveled e.g. (miles), 4) size of battery (e.g. kWh, which can also be expressed as range in miles for electric vehicles), 5) road category (e.g. paved highway), 6) maximum speed (e.g. mph), 7) road elevation profile, and 8) electric vehicle type and weight.

Using the datasets from the first AI model and the additional datasets outlined above, the second trained AI model simulates the journey of the electric vehicle along delivery route determined by the first AI model to the optimal route based on expected battery consumption (i.e. route 412). For instance, the second trained AI model simulates an electric car traveling along route 412 having a battery size of 100 kWh traveling 9.7 miles across a paved single lane road with a maximum speed limit of 35 mph, and predicting four stops at stoplight intersections. The simulated journey along route 412 passes a total of two battery service options 415e and 415b proximate the route 412, which means there are less opportunities to recharge along the way compared to route 411. The simulation can also include simulating a recharging time associated with using the battery service options 415e, 415b along the delivery route, and simulating whether a battery swap is possible without causing a time delay. The second trained AI model may then simulate the same journey with an electric motorbike, and then with an electric truck, or other type of electric vehicle.

In other embodiments, using the datasets from the first AI model and the additional datasets outlined above, the second trained AI model simulates the journey of the electric vehicle along each of the potential routes. For instance, in addition to the simulation along route 412, the second trained AI model simulates an electric car traveling along route 411 having a battery size of 100 kWh traveling 8.2 miles across a paved county road that passes through a hilly region of the city, with a maximum speed limit of 40 mph, and predicting only one stop at a stop sign. The simulated journey along route 411 passes a total of four battery service options 415f, 415a, 415b, and 415c proximate the route 411, which means there are ample opportunities to recharge along the way. The simulation can also include simulating a recharging time associated with using the battery service options 415f, 415a, 415b, and 415c. along the delivery route, and simulating whether a battery swap is possible without causing a time delay. The second trained AI model simulates an electric car traveling along route 413 having a battery size of 100 kWh traveling 14.6 miles across a paved highway road with a maximum speed limit of 35 mph, and predicting no stops. The simulated journey along route 413 passes a total of two battery service options 415e and 415d proximate the route 413, which means there are less opportunities to recharge along the way compared to route 411, and the same as route 412. The simulation can also include simulating a recharging time associated with using the battery service options 415e and 415d along the delivery route, and simulating whether a battery swap is possible without causing a time delay. The second trained AI model may then simulate the journeys 411 and 413 with an electric motorbike, and then with an electric truck, or other type of electric vehicle.

Based on the simulated journeys along the selected delivery route 412, or based on simulation of all potential routes 411, 412, 413, the second trained AI model can output an optimal battery size configuration to be used instead of the initial or factory battery size (e.g. 100 kWh). Additionally, the second trained AI model can output a recommended battery service schedule to ensure completion of the journey, especially when the electric vehicle continues to new destinations along new routes.

In step 310, the battery pack/service plan configuration module 210, using the second trained AI model, configures a size of a battery pack to be used with the electric vehicle at a start of the delivery route at the first location, as a function of the multiple simulations. Based on the simulation, the second trained AI model determines that the size of the starting battery pack (i.e. 100 kWh) can be reduced and still accomplish the delivery operation. The second trained AI model iteratively analyzes smaller and smaller (e.g. 90 kWh, 80 kWh, 70 kWh, 60 kWh, etc.) battery sizes until the model determines that a battery size would be too small to adequately complete the delivery option. The iterative process can be performed incrementally, for example, reducing the battery size by 10 kWh, but the number of iterations and the value of the increments may be reduced over time as the second AI model learns and becomes more efficient through continuous training of the second AI model, described in greater detail infra. The second trained AI model considers the need to charge the battery pack at the battery service options along the delivery route, and the time associated with charging. While a smaller battery size could be used, the number of stops required to charge the battery pack and the time required at the battery service option to charge the battery pack may violate delivery time constraints. Thus, the second trained AI model determines an optimal battery size that considers delivery time constraints but reduces the size of the battery pack required for delivery completion.

The optimal configuration of the size of the battery pack output by the second trained AI model is used to physically alter the battery pack of the electric vehicle. In an embodiment, the optimal configuration output by the second trained AI model requires that a service technician remove one or more battery cells from the battery pack prior to the electric vehicle leaving a facility to deliver the parcels, which lightens the load of the vehicle and thereby reduces a carbon footprint per parcel delivered. In another embodiment, the optimal configuration output by the second trained AI model requires the service technician swap out one type of battery cells with battery cells of a different type, perhaps made by another manufacturer or contains less energy per cell. In another embodiment, the optimal battery configuration output by the second trained AI model suggests that a different type of electric vehicle be used for the delivery operation, such as swapping out an electric delivery truck with an electric delivery car.

In step 312, the battery pack/service plan configuration module 210 configures a battery pack service schedule for servicing the battery pack along the delivery route, as a function of the multiple simulations. As the electric vehicle reaches the first destination of the one or more destinations, the process described above can be repeated to determine the best route to the next destination measured from the most recent delivery destination, and whether additional modifications or services to the battery can be carried out to reduce carbon emissions on a per parcel level, now with less total weight of the parcels. For instance, the battery pack/service plan configuration module 210 inputs new datasets into the second trained AI model with updated total weight of the parcels, an updated destination, and a current battery charge state. The second trained AI model outputs a battery pack service schedule to determine when and where the electric vehicle should stop at a battery service option. In an embodiment, the battery pack service schedule suggests that the electric vehicle should stop and recharge at a wired charging station and charge for “x” amount or time or to “z” percent full charge of the current battery pack that was initially modified at the starting facility. In an embodiment, the battery pack service schedule suggests that the electric vehicle should stop at a battery pack technician service so that an operator can add or remove one or more battery packs to increase or decrease a size of the battery pack, with the aim of reducing carbon emissions on a per parcel basis.

In step 314, the emissions allocation module 214 converts an energy consumed by the electric vehicle along the delivery route to carbon emissions, and allocates the carbon emissions to each parcel based on a weight of the parcel and distance the electric vehicle travels with the parcel. A carbon footprint per unit of parcel is calculated given the calculated energy consumption per delivery route and the total number of parcels on the electric delivery vehicle. A carbon footprint per parcel weight is calculated given the calculated energy consumption per delivery route and the total weight of parcels on the electric delivery vehicle. These values are modified each time the battery pack is physically altered, services, or recharged, based on leveraging one or more AI models. Values corresponding to the carbon footprint per unit of parcel or per parcel weight can be displayed on a display, for example as a key performance indicator on a GUI used by the shipping and logistics company. With this information, battery pack configurations are modified, electric vehicles are replaced with more efficient electric vehicles at a granular level.

### Relationship Between Artificial Intelligence Models

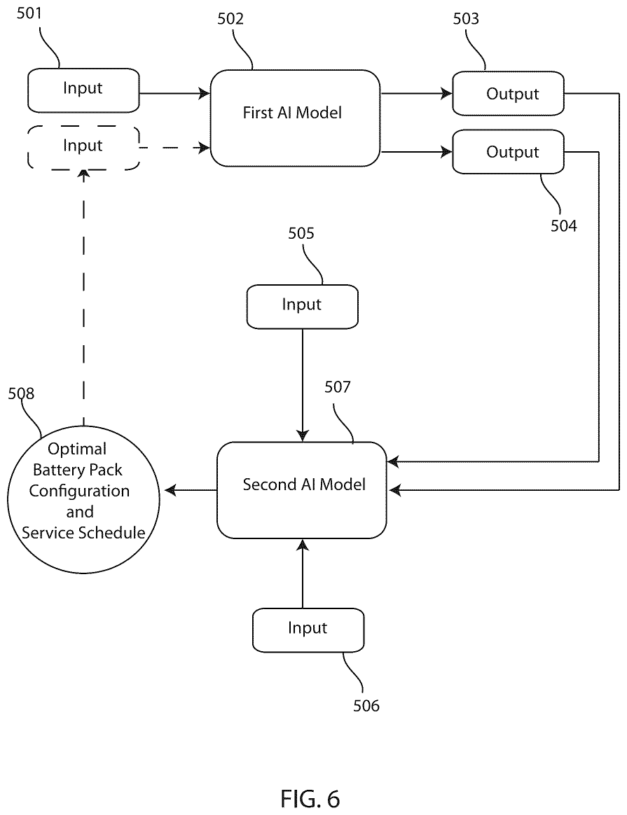

FIG. 6 depicts relationships between a first AI model 502 and a second AI model 507, in accordance with embodiments of the present invention. A carbon footprint per parcel associated with transport and delivery of parcels using electric vehicles can be reduced with the use of multiple artificial intelligence (AI) models 502, 507. The first AI model 502 forecasts expected battery consumption of a battery pack of an electric vehicle to complete a delivery operation along one or more routes (see output 503), and identifies the route with the lowest battery consumption (see output 504), using input 501. The outputs 503, 504 of the first AI model 502 is input into the second AI model 507, along with input 505 including datasets regarding battery service options, and input 506 regarding road profile information including elevation change, road category, maximum speed permitted, and road elevation profile, and electric vehicle type and weight. Some of the inputs represented by input 506 are also used as inputs for the first AI model 502, which can be compared with the results determined by the first AI model 502. The second AI model 507 thus leverages the outputs 503 and 504 of the first AI model 502 to output optimized battery pack configurations and battery pack service schedule, see output 508 based on the goal of reducing an carbon footprint per parcel caused by emissions resulting from transportation and delivery of parcels using electric vehicles. The optimized battery pack configurations and battery pack service schedule are dynamically updated by leveraging the multiple AI models using new inputs driven by updated road profiles, parcel weight, current battery charge states, weather conditions, traffic conditions, and other inputs discussed herein.

The second trained AI model 507 thus relies on one or multiple outputs of another model to physically modify the battery pack configuration of an electric vehicle that will reduce a carbon footprint on a parcel level associated with the delivery of parcels. In other words, the inputs of the second trained AI model 507 are the outputs of the previous AI model 502 which improve over time after each iteration. By feeding outputs of a first AI model 502 into a second trained AI model, the second trained AI model 507 is continuously being improved over time, and the modifications to the outputs of the previous models by the second trained AI model 507 are improved.

Moreover, the output 508 of the second trained AI model 507 is fed back into the first trained AI model 502 along with input 501. The output 508 is optimized battery pack configurations and battery pack service schedule, and by feeding the output 508 of the second trained AI model 507 into the first trained AI model 502, the outputs of the first trained AI model 502 and output 508 of the second trained AI model 507 are improved with knowledge of existing optimal battery pack configurations and service schedules calculated for new road profiles which may be similar to other road profiles previously fed through the AI models. Thus, a continuous cycle of machine learning is leveraged to reduce carbon footprints associated with battery consumption of electric vehicles during transport/deliveries of parcels, and can improve over time even as delivery destinations and associated road profiles change.

### Training the First AI Model

A training module of code 200 trains the first AI model using supervised machine learning or unsupervised machine learning. In an exemplary embodiment, the model's algorithm is trained to predict battery consumption across potential routes and to select the route based on the lowest battery consumption using elevation change, distance traveled, size of battery, total weight of parcels loaded or planned to be loaded on the electric vehicle, total weight of the electric vehicle, estimated travel time, road category, maximum speed, road elevation profile, weather conditions, traffic conditions, electric vehicle specifications, road curvature, number of turns, number of expected stops, number of stoplights, and delivery time constraints.

Input samples are fed into one or more neural networks to obtain a first vector and a second vector. An example of a first input sample is an elevation change over 50 feet, and the second input sample is an energy value required to propel an electric vehicle weighing 4,000 pounds for one mile. Another example of a first input sample is a time associated with stopping for 30 seconds in an idle position, and the second input sample is a drop in charge state of a battery while idle for 30 seconds. Another example of a first input sample is a road profile indicating highway conditions and the second input sample is a road profile that has stoplights and many intersections. A number between 0 and 1 is calculated using a cosine similarity function of the first vector and the second vector. The number closer to 1 indicates a match between the sample types, and the number closer to 0 indicates that the sample types do not match. A knowledge graph using the relative relationship of the at least two inputs is built and translated into readable text to understand impact on battery consumption. The inputs can be represented on the knowledge graph, along with the relative relationship to each other. The knowledge graph is translated into machine readable natural language using a natural language generation method based on data of the knowledge graph in the graph form to organize a semantic information of each node of the knowledge graph into a continuous natural language temporary text, which is then translated into the machine readable natural language using a natural language style transfer method. In this way, the first AI model is trained to learn what parameters increase battery consumption and what parameters reduce battery consumption.

### Training the Second AI Model

The second AI model may be trained by supervised machine learning or unsupervised machine learning, implanted via a training module of code 200. In an exemplary embodiment, the model's algorithm is trained to understand what size battery packs can be used to reduce carbon emissions for a given delivery route from point A to point B, and what service schedules maintain the proper battery capacity over time. Input samples are fed into one or more neural networks to obtain a first vector and a second vector. An example of a first input sample is 60 kWh battery, and the second input sample is a battery consumption rate over 10 miles. Another example of a first input sample is an electric car having a battery size of 100 kWh, and the second input sample is battery consumption rate over 20 miles. Another example of a first input sample is a road profile indicating highway conditions and the second input sample is a road profile that has stoplights and many intersections. A number between 0 and 1 is calculated using a cosine similarity function of the first vector and the second vector. The number closer to 1 indicates a match between the sample types, and the number closer to 0 indicates that the sample types do not match. A knowledge graph using the relative relationship of the at least two inputs is built and translated into readable text to understand impact on carbon emissions. The inputs can be represented on the knowledge graph, along with the relative relationship to each other. The knowledge graph is translated into machine readable natural language using a natural language generation method based on data of the knowledge graph in the graph form to organize a semantic information of each node of the knowledge graph into a continuous natural language temporary text, which is then translated into the machine readable natural language using a natural language style transfer method. In this way, the second AI model is trained to learn what parameters require smaller or larger battery packs.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
receiving, by one or more processors of a computer system, parcel delivery instructions including parcel level information, at least one electric vehicle property, and a first location and one or more destinations;
using, by the one or more processors, a first trained artificial intelligence model to extract, from a plurality of potential routes connecting the first location to the one or more destinations, an expected battery consumption of the electric vehicle for each of the plurality of potential routes, and to identify, based on the expected battery consumption, a delivery route to be used by the electric vehicle that has a lowest expected battery consumption;
mapping, by the one or more processors, battery service options along the delivery route output by the first trained artificial intelligence model;
performing, by the one or more processors, one or multiple simulations of the electric vehicle completing the parcel delivery instructions along the delivery route by inputting outputs of the first trained artificial intelligence model into a second trained artificial intelligence model; and
configuring, by the one or more processors, a size of a battery pack to be used with the electric vehicle at a start of the delivery route at the first location, and a battery pack service schedule for servicing the battery pack along the delivery route, as a function of the second artificial intelligence model performing the multiple simulations.

2. The computer-implemented method of claim 1, further comprising:
converting, by the one or more processors, an energy consumed by the electric vehicle along the delivery route to carbon emissions;
allocating, by the one or more processors, the carbon emissions to each parcel based on a weight of the parcel and distance the electric vehicle travels with the parcel;
calculating, by the one or more processors, a carbon footprint per unit of parcel; and
displaying, by the one or more processors, a value corresponding to the carbon footprint per unit of parcel on a display.

3. The computer-implemented method of claim 1, wherein the at least one electric vehicle property includes a total weight of the electric vehicle, an initial weight of a battery pack, and an initial capacity of the battery pack.

4. The computer-implemented method of claim 1, wherein the parcel level information includes a total number of parcels being transported by the electric vehicle and a weight of each parcel.

5. The computer-implemented method of claim 1, wherein the first trained artificial intelligence model uses a plurality of inputs to output the expected battery consumption, the plurality of inputs including a total weight of the parcels, a road profile of the plurality of potential routes, a vehicle speed, weather conditions, and traffic conditions.

6. The computer-implemented method of claim 1, wherein the road profile conditions include a curvature of a road, elevation changes of the road along a potential route, and an intensity of the elevation changes.

7. The computer-implemented method of claim 1, wherein the battery service options include wireless power transmission services, battery swapping services, and wired charging stations.

8. The computer-implemented method of claim 1, wherein the multiple simulations include simulating a recharging time associated with using one or more battery services along the delivery route, and simulating whether a battery swap is possible without causing a time delay.

9. A computer program product for configuring battery packs that minimize a carbon footprint of a parcel, the computer program product comprising a computer readable hardware storage medium having program instructions embodied therewith, the program instructions readable by one or more processors of a computer system to cause the one or more processors to:
receive parcel delivery instructions including parcel level information, at least one electric vehicle property, and a first location and one or more destinations;
use a first trained artificial intelligence model to extract, from a plurality of potential routes connecting the first location to the one or more destinations, an expected battery consumption of the electric vehicle for each of the plurality of potential routes, and to identify, based on the expected battery consumption, a delivery route to be used by the electric vehicle that has a lowest expected battery consumption;
map battery service options along the delivery route output by the first trained artificial intelligence model;
perform one or multiple simulations of the electric vehicle completing the parcel delivery instructions along the delivery route by inputting outputs of the first trained artificial intelligence model into a second trained artificial intelligence model; and
configure a size of a battery pack to be used with the electric vehicle at a start of the delivery route at the first location, and a battery pack service schedule for servicing the battery pack along the delivery route, as a function of the second artificial intelligence model performing the multiple simulations.

10. The computer program product of claim 9, wherein the one or more processors are caused to:
convert an energy consumed by the electric vehicle along the delivery route to carbon emissions;
allocate the carbon emissions to each parcel based on a weight of the parcel and distance the electric vehicle travels with the parcel;
calculate a carbon footprint per unit of parcel; and
display a value corresponding to the carbon footprint per unit of parcel on a display.

11. The computer program product of claim 9, wherein the at least one electric vehicle property includes a total weight of the electric vehicle, an initial weight of a battery pack, and an initial capacity of the battery pack.

12. The computer program product of claim 9, wherein the parcel level information includes a total number of parcels being transported by the electric vehicle and a weight of each parcel.

13. The computer program product of claim 9, wherein the trained artificial intelligence model uses a plurality of inputs to output the expected battery consumption, the plurality of inputs including a total weight of the parcels, a road profile of the plurality of potential routes, a vehicle speed, weather conditions, and traffic conditions.

14. The computer program product of claim 9, wherein the road profile conditions include a curvature of a road, elevation changes of the road along a potential route, and an intensity of the elevation changes.

15. The computer program product of claim 9, wherein the multiple simulations include simulating a recharging time associated with using one or more battery services along the delivery route, and simulating whether a battery swap is possible without causing a time delay.

16. A computer system comprising:
one or more computer processors;
one or more computer readable storage media; and
computer readable code stored collectively in the one or more computer readable storage media, with the computer readable code including data and instructions to cause the one or more computer processors to perform at least the following operations:
receiving, by the one or more processors, parcel delivery instructions including parcel level information, at least one electric vehicle property, and a first location and one or more destinations;
using, by the one or more processors, a first trained artificial intelligence model to extract, from a plurality of potential routes connecting the first location to the one or more destinations, an expected battery consumption of the electric vehicle for each of the plurality of potential routes, and to identify, based on the expected battery consumption, a delivery route to be used by the electric vehicle that has a lowest expected battery consumption;
mapping, by the one or more processors, battery service options along the delivery route output by the first trained artificial intelligence model;
performing, by the one or more processors, one or multiple simulations of the electric vehicle completing the parcel delivery instructions along the delivery route by inputting outputs of the first trained artificial intelligence model into a second trained artificial intelligence model; and
configuring, by the one or more processors, a size of a battery pack to be used with the electric vehicle at a start of the delivery route at the first location, and a battery pack service schedule for servicing the battery pack along the delivery route, as a function of the second artificial intelligence model performing the multiple simulations.

17. The computer system of claim 16, further comprising:
converting, by the one or more processors, an energy consumed by the electric vehicle along the delivery route to carbon emissions;
allocating, by the one or more processors, the carbon emissions to each parcel based on a weight of the parcel and distance the electric vehicle travels with the parcel;
calculating, by the one or more processors, a carbon footprint per unit of parcel; and
displaying, by the one or more processors, a value corresponding to the carbon footprint per unit of parcel on a display.

18. The computer system of claim 16, wherein the trained artificial intelligence model uses a plurality of inputs to output the expected battery consumption, the plurality of inputs including a total weight of the parcels, a road profile of the plurality of potential routes, a vehicle speed, weather conditions, and traffic conditions.

19. The computer system of claim 16, wherein the road profile conditions include a curvature of a road, elevation changes of the road along a potential route, and an intensity of the elevation changes.

20. The computer system of claim 16, wherein the multiple simulations include simulating a recharging time associated with using one or more battery services along the delivery route, and simulating whether a battery swap is possible without causing a time delay.
